(19) United States
(12) Patent Application Publication
(10) Pub. No.: US 2019/0279289 A1
(43) Pub. Date: Sep. 12, 2019

(54) CONTENT ITEM DISTRIBUTION BASED ON USER INTERACTIONS

(71) Applicant: Google Inc., Mountain View, CA (US)

(72) Inventors: Shumeet Baluja, Leesburg, VA (US); Joshua J. Sacks, Woodside, CA (US); Michael Chu, Los Altos Hills, CA (US); Zhengrong Ji, Sunnyvale, CA (US); Michele Covell, Palo Alto, CA (US)

(21) Appl. No.: 15/346,907

(22) Filed: Nov. 9, 2016

Related U.S. Application Data
(63) Continuation of application No. 14/145,628, filed on Dec. 31, 2013, now abandoned.
Application No. 14/145,628 is a continuation of application No. 13/959,247, filed on Aug. 5, 2013, now abandoned.

(51) Int. Cl. G06Q 30/08; H04L 12/26

(52) U.S. Cl. CPC G06Q 30/08; H04L 43/0876

(57) ABSTRACT

Methods, systems, and apparatus for content item distribution based on user interactions. In one aspect, a method includes identifying a set of conversion events associated with a content item provider, each conversion event having a corresponding device identifier; identifying, for each conversion event, a number of pre-conversion interactions that i) occurred prior to the conversion event, and ii) are associated with a device identifier that corresponds to the conversion event; generating, for the content item provider, a conversion profile specifying a portion of the conversion events that are associated with different pre-conversion interaction values; and generating, based on the conversion profile, a bid profile specifying different bid values for different pre-conversion interaction values, a difference between the different bid values being based on a difference between the portion of the conversion events that are associated with the different pre-conversion interaction values corresponding to the different bid values.

### CROSS-REFERENCE TO RELATED APPLICATIONS

This application is a continuation of U.S. patent application Ser. No. 14/145,628, filed Dec. 31, 2013, which is a continuation of U.S. patent application Ser. No. 13/959,247, filed Aug. 5, 2013, the disclosure of each are incorporated herein by reference in their entirety.

### BACKGROUND

This specification relates to distributing content items based on user interactions.

The Internet has enabled access to a wide variety of resources, e.g., video and/or audio files, web pages for particular subjects, news articles, etc. Access to these resources has likewise enabled opportunities to provide additional content with the resources. For example, a user device may request a resource, such as a search results page from a search engine, by submitting a search query to a search engine. The search results page includes instructions that cause the user device to request content items for presentation with the search results page. Content items that may be of interest to a user can be identified by a content management system in response to the user request. The request can include information the content management system can use to identify and, optionally, rank the content items so that the content items are selected and presented to the user according to the rank.

### SUMMARY

This specification describes technologies relating to content item distribution based on user interactions.

In general, one innovative aspect of the subject matter described in this specification can be embodied in methods that include the actions of identifying a set of conversion events associated with a content item provider, each conversion event having a corresponding device identifier; identifying, for each of one or more conversion events in the set of conversion events, a pre-conversion interaction value specifying a number of pre-conversion interactions that i) occurred prior to the conversion event, and ii) are associated with a device identifier that corresponds to the conversion event; generating, for the content item provider, a conversion profile specifying a portion of the one or more conversion events that are associated with each of two or more different pre-conversion interaction values; and generating, based on the conversion profile, a bid profile specifying different bid values for different pre-conversion interaction values, a difference between two of the different bid values being based on a difference between the portion of the one or more conversion events that are associated with the different pre-conversion interaction values corresponding to the two different bid values. Other embodiments of this aspect include corresponding systems, apparatus, and computer programs, configured to perform the actions of the methods, encoded on computer storage devices.

These and other embodiments can each optionally include one or more of the following features. The method may include identifying conversion event buckets for the set of conversion events, each conversion event bucket corresponding to one or more different pre-conversion interaction values, and each conversion event bucket having a bucket value that corresponds to a sum of each portion of the one or more conversion events that are associated with each different pre-conversion interaction value that corresponds to the conversion event bucket.

Generating a bid profile for the content item provider that specifies different bid values for one or more different pre-conversion interaction values may comprise: generating a bid profile for the content item provider that specifies bid values for the buckets, where at least one bid value for one bucket is different from another bid value for another bucket.

Each difference between bid values for the buckets may be based on a difference between the bucket values. Each conversion event in the set of conversion events may be of a same conversion type of a plurality of conversion types.

The method may include providing the content item provider with data that causes display of a graphical representation of the conversion profile; and receiving, from the content item provider, input that specifies different bid values for different pre-conversion interaction values, wherein the bid profile is generated based on the received input.

The method may include receiving a content item request from a user device, the content item request including a device identifier that corresponds to the user device; determining an interaction value for the user device, the interaction value specifying a number of interactions the user device had with a resource managed by the content item provider; identifying a bid value for the content item request based on the interaction value and the bid profile; and submitting a bid for the content item request to a content item auction, the bid being based on the identified bid value.

Particular embodiments of the subject matter described in this specification can be implemented so as to realize one or more of the following advantages. Conversion profiles can provide publishers with information regarding the effectiveness of their websites and resources with respect to conversions. Bid profiles facilitate distribution of content items in a manner that takes into account conversion statistics and pre-conversion interactions with user devices, which enables content item providers to reach users that are likely to be interested in the content items and the products or services offered by the content item provider. Conversion and bid profiles also allow content item providers also gain insight regarding costs of distributing content items to these interested users. Providing content items of interest to users, in turn, leads to satisfaction of users' informational needs.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which content items are distributed based on user interactions.

FIG. 2 is an illustration of an example process for generating a conversion profile and a bid profile.

FIG. 3 is an illustration of an example process for providing a content item to a user device using a bid profile.

FIG. 4 is a flow diagram of an example process in which a bid profile is generated.

FIG. 5 is a block diagram of an example data processing apparatus.

Like reference numbers and designations in the various drawings indicate like elements.

### DETAILED DESCRIPTION

A content management system identifies conversion events for a content item provider and creates a bid profile for the content item provider based on numbers of user interactions that occurred prior to the conversions. The bid profile is then used to modify the content item provider's bids for subsequent content item requests. In some implementations, a bid is modified based on a number of user interactions that have been performed by a user to whom the content item will be presented.

For example, the content management system may identify each instance of a user registration for a website belonging to an advertiser as a conversion event. For each conversion event, a number of user interactions occurring prior to the conversion are determined. For example, for each user registration, the content management system determines how many times each user device visited the website before registering. Using this information, a conversion profile is generated for the website.

In some implementations, the conversion profile indicates, for each number of user interactions, a number of the user devices that converted after that number of user interactions. For example, the conversion profile for the website may indicate that 7 users registered after the first visit, 25 users registered after the second visit 13 users registered after the third visit, and so on.

A bid profile is generated for the content item provider based on the conversion profile. In some implementations, the bid profile specifies bid values for different numbers of user interactions. Given the example numbers above, a bid profile for the website may specify bid multipliers for each number of visits, such as 0.5 for the first visit, 1.5 for the second visit, and 1.0 for the third visit. The content management system may use the bid profile to adjust bids for content items based on the number of times a user device that has requested content items has visited a website associated with the content item.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

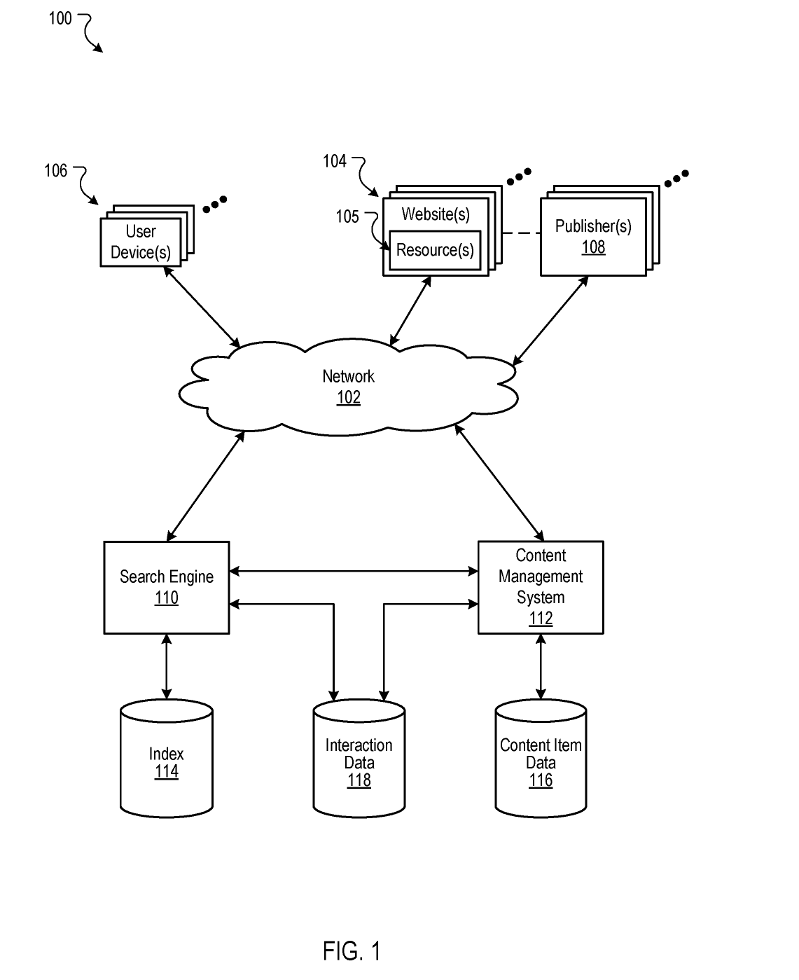

FIG. 1 is a block diagram of an example environment 100 in which content items are distributed based on user interactions. A computer network 102, such as a local area network (LAN), wide area network (WAN), the Internet, or a combination thereof, connects publisher web sites 104, user devices 106, publishers 108, a search engine 110, and a content management system 112. The online environment 100 may include many thousands of publisher web sites 104 and user devices 106.

A website 104 includes one or more resources 105 associated with a domain name and hosted by one or more servers. An example website is a collection of web pages formatted in hypertext markup language (HTML) that can contain text, images, multimedia content, and programming elements, such as scripts. Each website 104 is maintained by a content publisher 108, which is an entity that controls, manages and/or owns the website 104.

A resource 105 is data that can be provided by the publisher 108 over the network 102 and that is associated with a resource address. Resources include HTML pages, word processing documents, and portable document format (PDF) documents, images, video, and feed sources, to name just a few. The resources can include content, such as words, phrases, pictures, and so on, and may include embedded information (such as meta information and hyperlinks) and/or embedded instructions (such as scripts).

A user device 106 is an electronic device capable of requesting and receiving resources over the network 102. Example user devices 106 include personal computers, mobile communication devices, and other devices that can send and receive data over the network 102. A user device 106 typically includes a user application, such as a web browser, to facilitate the sending and receiving of data over the network 102. The web browser can enable a user to display and interact with text, images, videos, music and other information typically located on a web page at a website.

To facilitate searching of these resources 105, the search engine 110 identifies the resources by crawling the publisher web sites 104 and indexing the resources provided by the publisher web sites 104. The indexed and, optionally, cached copies of the resources, are stored in an index 114.

The user devices 106 submit search queries to the search engine 110. In response to the search request, the search engine 110 uses the index 114 to identify resources that are relevant to the queries. The search engine 110 identifies the resources in the form of search results and returns the search results to the user devices 106 in search results page resource. A search result is data generated by the search engine 110 that identifies a resource that satisfies a particular search query, and includes a resource locator for the resource. An example search result can include a web page title, a snippet of text extracted from the web page, and the URL of the web page.

The user devices 106 receive the search results pages and render the pages for presentation to users. In response to the user selecting a search result at a user device 106, the user device 106 requests the resource identified by the resource locator included in the selected search result. The publisher of the web site 104 hosting the resource receives the request for the resource from the user device 106 and provides the resource to the requesting user device 106.

In some implementations, queries and other data submitted by user devices 106 and related selection data may be stored in one or more data stores, such as a selection database or a query log. The log(s) and/or database(s) generally include records of occurrences of search results that are presented and search results that are selected for each received search query. A selection of a search result can be, e.g., a user action made with respect to the search result that initiates a request for the resource identified by the search result. For example, the user action with respect to the search result may be a “click” on the search result using the cursor of an input device, a voice-based selection, or a selection by a user's finger on a presence-sensitive input mechanism, e.g., a touch-screen device, or any other appropriate selection mechanism. In some implementations, selection data may not be tethered to the identity of individual users. A selection log, for example, may be used to determine selection rates and selection duration values for websites or other entities. Query and selection data can thus be used by the search engine to determine the sequence of queries submitted by the user devices, the actions taken in response to the queries, and how often the queries are submitted.

The content management system 112 facilitates the provisioning of content items with the resources 105. In particular, the content management system 112 allows content item providers to define rules that take into account attributes of particular user devices to provide specific content items for the user devices. Example rules include keyword-based serving, in which content item providers provide bids for keywords that are present in either search queries or webpage content. Content items that are associated with keywords having bids that result in a content item slot being awarded in response to an auction are selected for displaying in the content item slots.

When a user of a user device 106 interacts with or otherwise selects a content item, the user device 106 generates a request for a landing page of the content item, which is typically a webpage of the content item provider. For example, the publishers 108 who are also content item providers may include advertisers, each having respective web pages, some of which are landing pages for advertisements of the advertisers.

The content items can be provided for many different resources, such as the resources 105 of the publishers 108, and on a search results page resource. For example, a resource 105 on a publisher's website 104 may include instructions that cause a user device 106 to request an advertisement or other content item from the content management system 112. The request may include, for example, a publisher identifier, a device identifier that identifies the requesting user device 106, and/or keyword identifiers related to the content of the resource 105. The content management system 120, in turn, provides an advertisement to the particular user device.

With respect to a search results page provided by the search engine 110, the user device renders the search results page and sends a request to the content management system 112, along with a device identifier and one or more keywords related to the query that the user provided to the search engine 110. The content management system 120, in turn, provides content items to the particular user device.

The content management system 112 includes a data storage system that stores content item data 116, such as campaign data and performance data for content items. For example, the campaign data stores content items, selection information, and budgeting information for content item providers. The performance data stores data indicating the performance of the content items that are served. Such performance data may include, for example, click through rates for content items, the number of impressions for content items, and the number of conversions for content items. Other performance data can also be stored.

The content item data 116 may be used as input parameters to a content item auction. For example, the content management system 112, in response to a request for content items, conducts an auction to select content items that are provided in response to the request. The content items may be ranked according to a score that, in some implementations, is a value determined based on a content item bid and one or more parameters specified in the content item data 116. The highest ranked content items resulting from the auction are selected and provided to the requesting user device.

The content management system 112 and, in some implementations, the search engine 110, may access interaction data 118 that stores data related to user device interactions with resources and/or content items. For example, in response to user selection of a search result, the search engine 110 may store a record that indicates a device identifier for a corresponding user device in the interaction data 118 along with a timestamp and data specifying the resource referenced by the search result. In response to user selection of a content item, the content management system 112 may store a device identifier for the corresponding user device in the interaction data 118 along with a timestamp and data specifying the resource referenced by the content item. In some implementations, publishers 108 provide the content management system 112 with data that specifies device identifiers and interactions recorded by the publisher for storage in the interaction data 118 data store.

For example, the interaction data 118 may indicate, for particular a particular resource, website, or publisher, a number of visits associated with a particular device identifier. Other information, such as a time for each visit, and whether or not a conversion occurred during that visit, may also be stored for each device identifier provided by a user device that visited the resource, website, or other publisher property.

As described in further detail below, the content management system 112 uses the interaction data 118 to generate a bid profile that will be used to facilitate the distribution of content items to user devices 106.

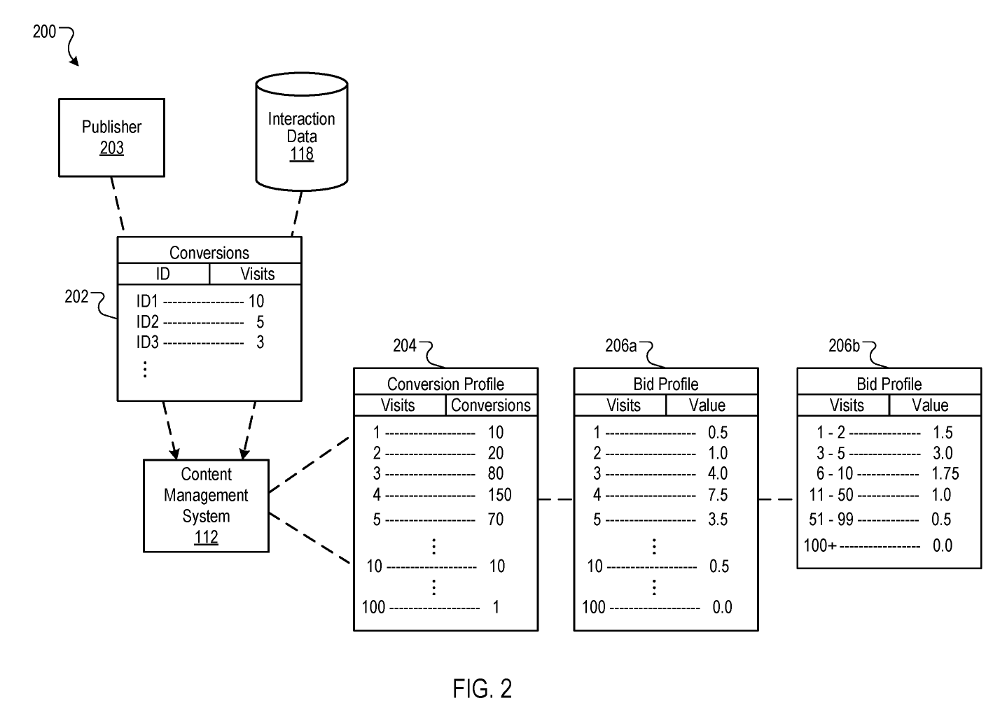

FIG. 2 is an illustration of an example process 200 for generating a conversion profile and a bid profile. In the example process 200, the content management system 112 identifies a set of conversion events 202 associated with a content item provider, such as the publisher 203. A conversion event is a particular interaction with a content item, resource, or website. Example conversion events include a user purchasing a product or service, a user registering for a website's newsletter, a user viewing a particular video, and a user downloading a particular file, just to name a few. Each conversion event has a corresponding device identifier that corresponds to the user device through which the conversion occurred.

In some implementations, conversion events are recorded by the publisher 203. For example, an advertiser may store a device identifier and other relevant information after each conversion on the advertiser's website and provide that information to the content management system 112. In some implementations, conversion events 202 are identified from interaction data 118 and/or content item data 116. For example, an advertiser's purchase confirmation resource may include instructions that cause the advertiser or user device to send a record of the conversion to the content management system 112 for storage in the content item data 116 and/or the interaction data 118.

In some implementations, each conversion event in the identified set of conversion events 202 is of a same conversion type. As discussed above, multiple conversion types exist, such as a purchase, a website registration, or a file download. The identified conversion events may only include one type of conversion, such as website registrations. Another example would be a purchase of a particular product, as opposed to the purchase of any product offered on a website. Other conversion events may be recorded separately, with their own identified sets of conversion events, or not at all. In some implementations, different types of conversion events can be identified and recorded together, such that multiple different conversion event types can be identified in a single set of conversion events.

For each conversion event identified by the content management system 112, a pre-conversion interaction value is identified. Pre-conversion interactions are actions taken by a user device prior to a conversion, and the pre-conversion interaction value specifies a number of pre-conversion interactions that occurred prior to a conversion. Pre-conversion interactions include, for example, visits to a particular website or resource, selections of a content item, and search queries issued, just to name a few. An example pre-conversion interaction value is the number of times a particular user device visited a particular website prior to purchasing a product sold on the website. The pre-conversion interaction value may be specific to one interaction type, or may represent a number of different interaction types.

In some implementations, other conversions may be considered pre-conversion interactions. For example, a pre-conversion interaction value may be the number of purchases made by a particular user from a particular website prior to the user registering for a service provided by the website.

In the example process 200, the user device associated with device identifier ID1 visited the publisher's 203 website 10 times prior to a conversion, the user device associated with device identifier ID2 visited the website 5 times prior to a conversion, and the user device associated with device identifier ID3 visited the website 3 times prior to a conversion.

The content management system 112 creates a conversion profile 204 for the publisher 203. The conversion profile 204 specifies, for each pre-conversion interaction value, the number of conversion events that correspond to that value. In the example process 200, the conversion profile 204 specifies that 10 conversions occurred after the first visit to a website, 20 conversions occurred after the second visit, 80 occurred after the third visit, and so on.

The content management system 112 generates a bid profile 206a based on the conversion profile. The bid profile 206a specifies bid values for different pre-conversion interaction values. In some implementations, bid values are actual bids, e.g., monetary amounts. In some implementations, bid values are multipliers to be applied to actual bid amounts to arrive at a modified bid amount. In the example process 200, the bid values are multipliers. The multiplier associated with 1 visit is 0.5, meaning that a specified bid will be multiplied by 0.5 to arrive at the modified bid value when 1 user interaction is determined to have occurred, the multiplier associated with 2 visits is 1.0, meaning that the specified bid will be multiplied by 1.0 when 2 user interactions are determined to have occurred, the multiplier associated with 3 visits is 4.0, meaning that the specified bid will be multiplied by 4.0 when 3 user interactions are determined to have occurred, and so on. As discussed in further detail below, the bid profile may be used by the content management system to determine an amount to be bid for presentation of a content item.

In some implementations, the bid values specified in a bid profile indicate a portion of a content item provider's budget to be allocated to the corresponding pre-conversion interaction values. Using the example conversion profile 204, an advertiser with a weekly advertising budget may wish to allocate more of its budget to advertising to user devices with 3, 4, or 5 visits to the advertiser's website than they would allocate to user devices with 1 or 2 visits to the advertiser's website, because more conversions took place after 3, 4, and 5 visits than took place after 1 or 2 visits.

In some implementations, the bid values may indicate a portion of a content item provider's periodic impressions to be allocated to the corresponding pre-conversion interaction values. As with the previous example, an advertiser who schedules 10,000 advertisement impressions per week may allocate more impressions to user devices with 3, 4, or 5 visits to the advertiser's website than they would allocate to user devices with 1 or 2 visits to the advertiser's website.

The differences between bid values may be based on the differences between the number of conversion events associated with each pre-conversion interaction value. In the example conversion profile 204 and bid profile 206a, 10 conversions occurred after 1 visit, while 20 occurred after 2 visits. Thus, the bid value for 2 visits is higher than the bid value for 1 visit. In some implementations, such as in the example bid profile 206a, the differences are proportional, e.g., the bid value for 2 visits is twice the bid value for 1 visit because there were twice as many conversions after the second visit than the first. In some implementations, a budget may be proportionally allocated based on the conversion profile. For example, if 15% of an advertiser's conversions came after 3 visits to the advertiser's website, the bid value for devices with 3 visits may be 15% of the advertiser's advertising budget.

In some implementations, the bid values are provided by the content item provider. For example, the content management system 112 may provide the conversion profile 204 to the publisher 203. The publisher 203 then provides bid values to the content management system 112 for each pre-conversion interaction value. In some implementations, the content management system 112 provides the content item provider with a graphical representation of the conversion profile, such as a histogram or graph, to assist the content item provider in assigning bid values.

The bid profile can be, for example, represented as a mathematical function generated based on the conversion profile. For example, a first mathematical function may be created using the data included in the conversion profile and a curve fitting process, such as an interpolation process or smoothing processes. The first function would accept a pre-conversion interaction value as input and provide output substantially similar to the number of conversions specified by the conversion profile. The first function may be modified to produce a second function that produces a bid value as output for a pre-conversion interaction value input. Other mathematical functions and/or processes may be used to create a function for determining bid values based on the conversion profile, such as linear and/or non-linear regression, real valued neural networks, logistic regression, Gaussian fitting, sigmoid fitting, and piece-wise linear regression, to name a few.

In some implementations, the content management system 112 identifies conversion event buckets using the conversion profile 204. Each conversion event bucket corresponds to one or more different pre-conversion interaction values, and each bucket also has a bucket value that corresponds to the sum of the conversion events for the bucket. Using the example numbers provided in the example conversion profile 204, a first conversion event bucket may be identified for visits 1 and 2, and a second conversion even bucket may be identified for visits 3 through 5. The bucket value for the first conversion bucket would be 30 (e.g., 10+20) and the bucket value for the second conversion bucket would be 300 (e.g., 80+150+70). In some implementations, a bucket may be open-ended, e.g., there may be one conversion bucket for all visits greater than 100.

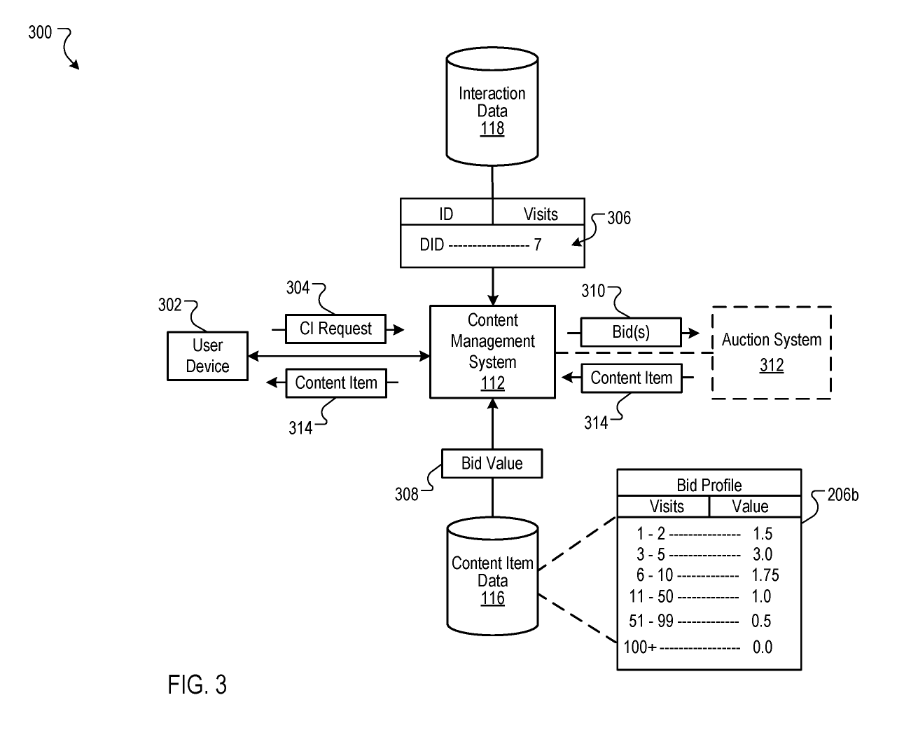

In some implementations, the bid profile is based on the conversion event buckets. In the example process 200, bid profile 206b specifies bid values for buckets of one or more pre-conversion interaction values. A bid value of 1.5 applies to 1-2 website visits, a bid value of 3.0 applies to 3-5 visits, and so on. As with the bid values described above, differences between bid values for the per-conversion interaction value buckets may be based on the differences between bucket values of the corresponding conversion event buckets. An example process for distributing content items to user devices is described below with reference to FIG. 3.

Multiple conversion profiles and bid profiles may be generated for a content item provider. For example, a content item provider may be a publisher of multiple websites, and have a conversion profile and bid profile for each website. Individual resources included in websites may also each have their own conversion and bid profile. For example, a website offering both products and services may have a conversion and bid profile for both a products web page and a services web page. In addition, each content item provider, website, or resource may have multiple conversion and bid profiles for different types of conversions. For example, a media sales website may offer a subscription service plan and a la carte purchases, with each type of conversion having its own conversion profile and bid profile.

FIG. 3 is an illustration of an example process 300 for providing a content item to a user device using a bid profile. The content management system 112 receives a content item request 304 from a user device 302, and the request 304 includes a device identifier that corresponds to the user device 302. The content management system 112 uses the device identifier to determine an interaction value for the user device 302. The interaction value 306 specifies a number of interactions with one or more resources of a content item provider that are attributed to the user device. In the example process 300, the content management system 112 uses the device identifier included in the request 304 to find how many times the user device 302 requested a particular content item provider's website—in this example, the interaction value 306 indicates that the user device 302 has requested a particular content item provider's website 7 times.

The content management system 112 identifies a bid value 308 for the content item request 304 based on the interaction value 306 and the bid profile 206b for the content item provider's website. In the example process 300, the interaction value 306 corresponds to the third bucket, e.g., 6-10 visits. The corresponding bid value 308 is identified as 1.75, which indicates a multiplier for a content item of the particular content item provider.

In some implementations, the content management system 112 formulates a bid for a content item of the particular content item provider, and submits the bid 310 to a content item auction system 312. A base bid may be obtained that is an amount the particular content item provider would normally bid for providing a content item to the user device 302. The base bid may then be adjusted using the bid value 308. For example, given a bid value 308 of 1.75 and a base bid of $1.00, base bid may be multiplied by the bid value to obtain an adjusted bid of $1.75. This adjusted bid 310 may then be provided to the auction system 312, which, as described above, uses bids and other metrics for this content item and compares them to bids and metrics for other content items to determine which content item 314 to provide to the user device 302. Once a content item 314 is selected, it is provided to the user device 302 for display.

In implementations where the bid profile specifies a portion of a budget for a content item provider, the content management system 112 may use the specified portion to determine whether a bid is submitted to the auction system 312 at all, and if so, how much to bid. For example, if a weekly budget allocation for delivering advertisements to user devices with 10 visits has already be used, the content management system 112 may not submit a bid to the auction system 312 for presentation of another advertisement to a user device with 10 previous visits.

While the auction system 312 is depicted as being separate from the content management system 112, in some implementations, the auction system 312 is part of the content management system 112.

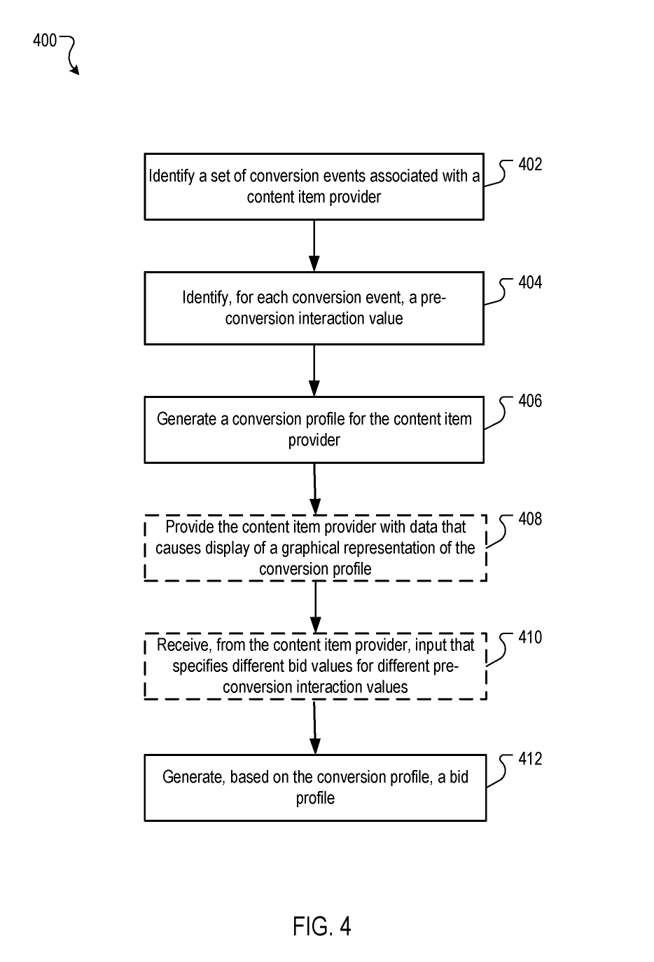

FIG. 4 is a flow diagram 400 of an example process in which a bid profile is generated. The process may be used by a data processing apparatus, such as the content management system, to generate a bid profile for a content item provider.

A set of conversion events associated with a content item provider is identified (402). Each conversion event has a corresponding device identifier. For example, a set of product purchases may be identified for an online retailer, and each product purchase is associated with a device identifier of a user device that was used to consummate the purchase. In some implementations, each conversion event in the set of conversion events is of a same conversion type. For example, each conversion event may be a purchase of a particular product; or, each conversion event may be a registration for a newsletter provided by a website.

For each conversion event in the set of conversion events, a pre-conversion interaction value is identified (404). The pre-conversion interaction value specifies a number of pre-conversion interactions that i) occurred prior to the conversion event, and ii) are associated with a device identifier that corresponds to the conversion event. For example, for each product purchase in a set of product purchases, a number of previous visits to the online retailer's website from the same user device associated with the product purchase is identified.

A conversion profile is generated for the content item provider (406). In some implementations, the conversion profile specifies a portion of the one or more conversion events that are associated with each of two or more different pre-conversion interaction values. For example, the conversion profile for the online retailer would specify, for each different number of visits to the online retailer's website, how many conversions occurred. Thus, an example conversion profile might specify that 10 conversions occurred after a user device's first visit to the online retailer's website, 50 conversions occurred after a user device's second visit to the online retailer's website, and so on.

In some implementations, the content item provider is optionally provided data that causes display of a graphical representation of the conversion profile (408). For example, the online retailer may be presented with a histogram that represents the conversion profile, with the horizontal axis of the histogram representing different numbers of pre-conversion visits, and the vertical axis representing the number of conversions that occurred after each of the different numbers of pre-conversion visits.

In some implementations, input that specifies different bid values for different pre-conversion interaction values is optionally received from the content item provider (410). For example, the online retailer may provide bid values for each different number of visits. The online retailer may specify, for example, one bid value for each number of visits up to the 20^{th} visit to the retailer's website, and a second bid value for each number of visits after the 20^{th} visit to the retailer's website.

A bid profile is generated based on the conversion profile (412). The bid profile specifies different bid values for different pre-conversion interaction values. In some implementations, a difference between two of the different bid values is based on a difference between the portion of the conversion events associated with the different bid values. For example, a bid profile for the online retailer may specify a bid value for visit 2 is higher than a bid value for visit 1 because more conversions occurred after the 2 visits than occurred after 1 visit.

In implementations where the content item provider provides input specifying different bid values for different pre-conversion interaction values, the bid profile may be based on the input. The content item provider's input may specify bid values for any of the pre-conversion interaction values; it need not specify bid values for all pre-conversion interaction values. For example, the online retailer may provide a bid value for the first visit to the retailer's website and for all visits after the 20^{th} website visit, while leaving the remaining bid values for visits 2-19 to be specified by the content management system.

As described above, bid profiles may be used to provide content items to user devices. For example, the online retailer has an advertisement that it would like to show to users, and the retailer is willing to pay more for an impression of the advertisement if it is shown to a user who is more likely to purchase a product on the retailer's website. The conversion profile for the retailer provides a historical indication of how likely a user is to purchase a product given a certain number of visits to the website. When the retailer's advertisement is eligible to be provided to a user device, the bid profile may be used to determine if a bid for the advertisement impression should be adjusted, and by how much, based on how many times the user device has visited the retailer's website before.

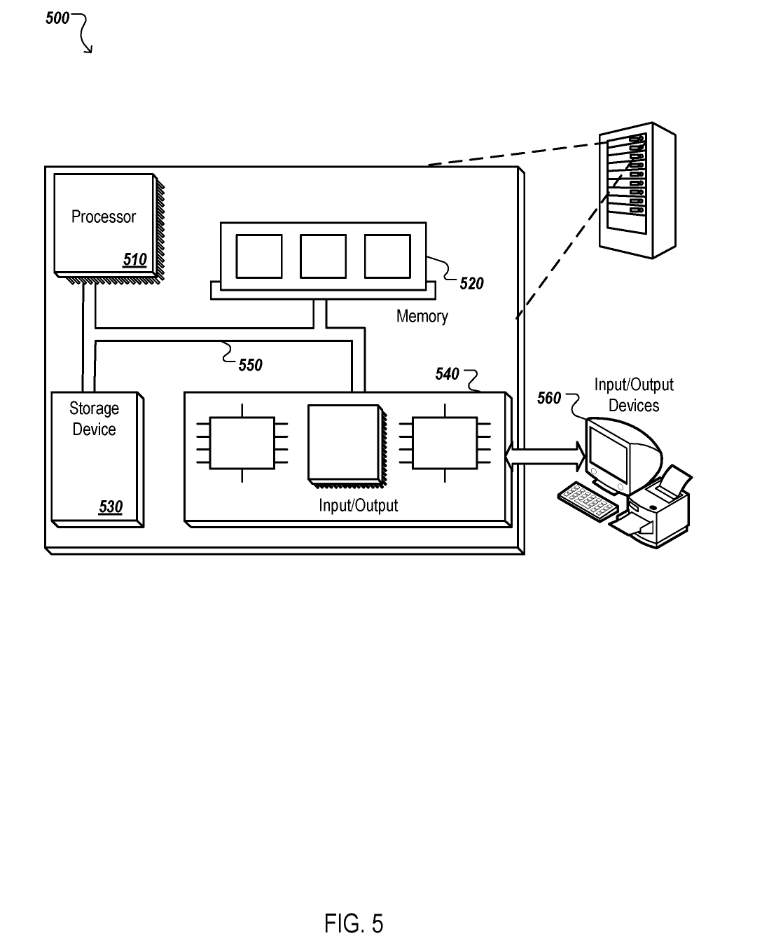

FIG. 5 is a block diagram of an example data processing apparatus 500. The system 500 includes a processor 510, a memory 520, a storage device 530, and an input/output device 540. Each of the components 510, 520, 530, and 540 can, for example, be interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can, for example, include a hard disk device, an optical disk device, or some other large capacity storage device.

The input/output device 540 provides input/output operations for the system 500. In one implementation, the input/output device 540 can include one or more network interface devices, e.g., an Ethernet card, a serial communication device, e.g., an RS-232 port, and/or a wireless interface device, e.g., an 802.11 card. In another implementation, the input/output device can include driver devices configured to receive input data and send output data to other input/output devices, e.g., keyboard, printer and display devices 560. Other implementations, however, can also be used, such as mobile computing devices, mobile communication devices, set-top box television client devices, etc.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., a FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a user computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. (canceled)

2. A computer-implemented method comprising:
receiving, by a content management system, data indicating a request to provide sponsored content for viewing by a particular user on a website of a first content provider;
identifying, by the content management system, a bid specified by a second, different content provider to provide sponsored content for viewing on the website of the first content provider;
determining, by the content management system, a number of times the particular user has visited a website of the second, different content provider;
based on the number of times the particular user has visited the website of the second, different content provider, adjusting, by the content management system, the bid specified by the second, different content provider to provide sponsored content for viewing on the website of the first content provider;
conducting, by the content management system, an auction using the bid, that was adjusted based on the number of times the particular user has visited the website of the second, different content provider, and other bids specified by other content providers to provide sponsored content for viewing on the website of the first content provider;
determining, by the content management system, that the bid, that was adjusted based on the number of times the particular user has visited the website of the second, different content provider, won the auction;
based on determining that the bid, that was adjusted based on the number of times the particular user has visited the website of the second, different content provider, won the auction, providing, by the content management system and for output, a sponsored content item provided by the second, different content provider for viewing by the particular user on the website of the first content provider; and
based on providing, for output, the sponsored content item for viewing by the particular user on the website of the first content provider, charging, by the content management system, the second, different content provider the bid, that was adjusted based on the number of times the particular user has visited the website of the second, different content provider.

3. The method of claim 2, wherein adjusting the bid comprises:
adjusting the bid to a first value based on the number of times the particular user has visited the website of the second, different content provider being within a first range; or
adjusting the bid to a second value based on a number of times the particular user has visited the website of the second, different content provider being within a second, different range.

4. The method of claim 3, wherein:
the first range is lower than the second, different range, and
the first value is greater than the second value.

5. (canceled)

6. The method of claim 2, comprising:
determining that, within a predetermined period of time, the particular user accessing the website of the second, different content provider included a conversion event; and
based on determining that, within the predetermined period of time, the particular user accessing the website of the second, different content provider included the conversion event, decreasing the adjusted bid.

7. The method of claim 2, comprising:
accessing, for each of a plurality of users, (i) data indicating a number of times a respective user had been presented any content by the second, different content provider and (ii) data indicating whether each presentation included a conversion event for the second, different content provider and a number of previous times the respective user had been presented any content by the second, different content provider before the conversion event,
wherein the adjusted bid is further adjusted based on (i) the data indicating the number of times the respective user had been presented any content by the second, different content provider and (ii) the data indicating whether each presentation included the conversion event for the second, different content provider and the number of previous times the respective user had been presented any content by the second, different content provider before the conversion event.

8. The method of claim 7, comprising:
determining a type of the conversion event for the second, different content provider,
wherein the adjusted bid is further adjusted based on the type of the conversion event for the second, different content provider.

9. A system comprising:
one or more computers and one or more storage devices storing instructions that are operable, when executed by the one or more computers, to cause the one or more computers to perform operations comprising:
receiving, by a content management system, data indicating a request to provide sponsored content for viewing by a particular user on a website of a first content provider;
identifying, by the content management system, a bid specified by a second, different content provider to provide sponsored content for viewing on the website of the first content provider;
determining, by the content management system, a number of times the particular user has visited a website of the second, different content provider;
based on the number of times the particular user has visited the website of the second, different content provider, adjusting, by the content management system, the bid specified by the second, different content provider to provide sponsored content for viewing on the website of the first content provider;
conducting, by the content management system, an auction using the bid, that was adjusted based on the number of times the particular user has visited the website of the second, different content provider, and other bids specified by other content providers to provide sponsored content for viewing on the website of the first content provider;
determining, by the content management system, that the bid, that was adjusted based on the number of times the particular user has visited the website of the second, different content provider, won the auction;
based on determining that the bid, that was adjusted based on the number of times the particular user has visited the website of the second, different content provider, won the auction, providing, by the content management system and for output a sponsored content item provided by the second, different content provider for viewing by the particular user on the website of the first content provider; and
based on providing, for output, the sponsored content item for viewing by the particular user on the website of the first content provider, charging, by the content management system, the second, different content provider the bid, that was adjusted based on the number of times the particular user has visited the website of the second, different content provider.

10. The system of claim 9, wherein adjusting the bid comprises:
adjusting the bid to a first value based on the number of times the particular user has visited the website of the second, different content provider being within a first range; or
adjusting the bid to a second value based on a number of times the particular user has visited the website of the second, different content provider being within a second, different range.

11. The system of claim 10, wherein:
the first range is lower than the second, different range, and
the first value is greater than the second value.

12. (canceled)

13. The system of claim 9, wherein the operations further comprise:
determining that, within a predetermined period of time, the particular user accessing the website of the second, different content provider included a conversion event; and
based on determining that, within the predetermined period of time, the particular user accessing the website of the second, different content provider included the conversion event, decreasing the adjusted bid.

14. The system of claim 9, wherein the operations further comprise:
accessing, for each of a plurality of users, (i) data indicating a number of times a respective user had been presented any content by the second, different content provider and (ii) data indicating whether each presentation included a conversion event for the second, different content provider and a number of previous times the respective user had been presented any content by the second, different content provider before the conversion event,
wherein the adjusted bid is further adjusted based on (i) the data indicating the number of times the respective user had been presented any content by the second, different content provider and (ii) the data indicating whether each presentation included the conversion event for the second, different content provider and the number of previous times the respective user had been presented any content by the second, different content provider before the conversion event.

15. The system of claim 14, wherein the operations further comprise:
determining a type of the conversion event for the second, different content provider,
wherein the adjusted bid is further adjusted based on the type of the conversion event for the second, different content provider.

16. A non-transitory computer-readable medium storing software comprising instructions executable by one or more computers which, upon such execution, cause the one or more computers to perform operations comprising:
receiving, by a content management system, data indicating a request to provide sponsored content for viewing by a particular user on a website of a first content provider;
identifying, by the content management system, a bid specified by a second, different content provider to provide sponsored content for viewing on the website of the first content provider;
determining, by the content management system, a number of times the particular user has visited a website of the second, different content provider;
based on the number of times the particular user has visited the website of the second, different content provider, adjusting, by the content management system, the bid specified by the second, different content provider to provide sponsored content for viewing on the website of the first content provider;
conducting, by the content management system, an auction using the bid, that was adjusted based on the number of times the particular user has visited the website of the second, different content provider, and other bids specified by other content providers to provide sponsored content for viewing on the website of the first content provider;
determining, by the content management system, that the bid, that was adjusted based on the number of times the particular user has visited the website of the second, different content provider, won the auction;
based on determining that the bid, that was adjusted based on the number of times the particular user has visited the website of the second, different content provider, won the auction, providing, by the content management system and for output, a sponsored content item provided by the second, different content provider for viewing by the particular user on the website of the first content provider; and
based on providing, for output, the sponsored content item for viewing by the particular user on the website of the first content provider, charging, by the content management system, the second, different content provider the bid, that was adjusted based on the number of times the particular user has visited the website of the second, different content provider.

17. The medium of claim 16, wherein adjusting the bid comprises:
adjusting the bid to a first value based on the number of times the particular user has visited the website of the second, different content provider being within a first range; or
adjusting the bid to a second value based on a number of times the particular user has visited the website of the second, different content provider being within a second, different range.

18. The medium of claim 17, wherein:
the first range is lower than the second, different range, and
the first value is greater than the second value.

19. (canceled)

20. The medium of claim 16, wherein the operations further comprise:
determining that, within a predetermined period of time, the particular user accessing the website of the second, different content provider included a conversion event; and
based on determining that, within the predetermined period of time, the particular user accessing the website of the second, different content provider included the conversion event, decreasing the adjusted bid.

21. The medium of claim 16, wherein the operations further comprise:
accessing, for each of a plurality of users, (i) data indicating a number of times a respective user had been presented any content by the second, different content provider and (ii) data indicating whether each presentation included a conversion event for the second, different content provider and a number of previous times the respective user had been presented any content by the second, different content provider before the conversion event,
wherein the adjusted bid is further adjusted based on (i) the data indicating the number of times the respective user had been presented any content by the second, different content provider and (ii) the data indicating whether each presentation included the conversion event for the second, different content provider and the number of previous times the respective user had been presented any content by the second, different content provider before the conversion event.

22. The method of claim 8, wherein:
determining the type of the conversion event for the second, different content provider comprises determining that the conversion event is signing up for a subscription service plan, and
the adjusted bid is increased based on determining that the conversion event is signing up for a subscription service plan.

23. The method of claim 8, wherein:
determining the type of the conversion event for the second, different content provider comprises determining that the conversion event is an a la carte purchase, and
the adjusted bid is decreased based on determining that the conversion event is an a la carte purchase.
